(19) United States
(12) Patent Application Publication
(10) Pub. No.: US 2019/0313746 A1
(43) Pub. Date: Oct. 17, 2019

(54) "Harness Connection Arrangement"

(71) Applicant: MSA Technology, LLC, Cranberry Township, PA (US)

(72) Inventor: Mitchell H. Hetrich, Greenville, PA (US)

(21) Appl. No.: 15/952,809

(22) Filed: Apr. 13, 2018

(51) Int. Cl. A44B 11/28; A62B 35/00; A44B 13/00; A44B 11/04

(52) U.S. Cl. CPC A44B 11/28; A62B 35/0025; A44D 2200/10; A44B 13/0029; A44B 11/04; A62B 35/0018

(57) ABSTRACT

A connection arrangement for use with a wearable body harness has a first connector having a body with a first portion of a locking mechanism and a second connector having a body with a second portion of the locking mechanism. The first portion of the locking mechanism has a tab connected to the body of the first connector and a slot having a first portion extending through the body of the first connector and a second portion extending through the tab. The second portion of the locking mechanism has a tongue configured for being received through the first portion of the slot, and an intermediate connecting element having a first end connected to the body of the second connector and a second end connected to the tongue. The second end of the intermediate connecting element is offset from the body of the second connector.

### BACKGROUND OF THE INVENTION

### Field of the Invention

The present invention relates generally to wearable body harnesses and, in particular, to a harness connection arrangement for use with wearable body harnesses.

### Description of the Related Art

As is known in the art, there exist various safety devices and arrangements that can be worn by or attached to a user to ensure the wearer's safety in certain situations. Such mechanisms come in many forms, including, but not limited to, harnesses and safety belts. Full body harnesses are widely used for lifting and lowering individuals in dangerous situations and as a primary component in a personal fall arrest system. These harnesses can also be used for work positioning, travel restriction, ladder climbing, rescue retrieval, and evacuation. While these harnesses are used mainly in an industrial setting, and particularly the construction industry where the likelihood and danger of falls from heights is both numerous and significant, a full body harness can be used in various other applications in which total suspension and support of the body must be ensured, either expectedly or unexpectedly.

While there are many variations in full body harness construction, all typically include a plurality of elongate straps that are combined together to fit around a user's body. In some embodiments or aspects, a full body harness may have an attachment point (D-ring) typically positioned in a central portion of the user's back or chest, and a plurality of straps routed around predetermined portions of the user's body in such a manner as to hold or suspend the user in the event of a fall. One or more straps of the harness may be removably connected together by a connector, such as a buckle.

While a variety of connectors exist in the art for connecting the straps f the harness, there is a continued need in the art for improved connectors. For example, there is a need for improved connectors that prevent tangling of harness straps. There is a further need in the art for improved connectors that can be easily and effectively connected and disconnected to allow quick donning and removal of the harness. There is also a need for improved connectors with increased safety compliance and redundant safety mechanisms.

### SUMMARY OF THE INVENTION

Generally, provided is an improved body harness having an improved harness connection arrangement. Preferably, provided is an improved harness having a harness connection arrangement that can be easily and effectively worn by the user in a variety of work environments without compromising the user's ability to move. Preferably, provided is a harness having a connector for connecting at least two straps of the harness, wherein the connector can be easily and effectively connected and disconnected to allow quick donning and removal of the harness. Preferably, provided is an improved harness having a harness connection arrangement that not only leads to increased safety compliance at the worksite, but also provides increased effectiveness and safety to the user.

In some preferred and non-limiting embodiments or aspects, a connection arrangement for use with a wearable body harness may have a first connector having a body with a first portion of a locking mechanism, and a second connector having a body with a second portion of the locking mechanism. The first portion of the locking mechanism may have a tab connected to the body of the first connector and angled at a predetermined angle relative to a plane defined by the body, and a slot having a first portion extending through the body of the first connector and a second portion extending through the tab. The second portion of the locking mechanism may have a tongue configured for being received through the first portion of the slot, and an intermediate connecting element having a first end connected to the body of the second connector and a second end connected to the tongue. The second end of the intermediate connecting element may be offset from the body of the second connector such that the intermediate connecting element is receivable in the second portion of the slot on the tab.

In other preferred and non-limiting embodiments or aspects, the first portion of the locking mechanism may be configured for interacting with the second portion of the locking mechanism to removably engage the first connector and the second connector between a first, locked configuration, where the first connector and the second connectors are connected to each other, and a second, unlocked configuration, where the first connector and the second connectors are disconnected from each other. The predetermined angle may be 30° to 180°. The first portion of the slot may have an angled end surface that is angled at an angle of 90° to 180° relative to lateral surfaces of the first portion of the slot. A width of the first portion of the slot may be narrower than a width of the tongue. A width of the second portion of the slot may be wider than a width of the intermediate connecting element. The tongue may be connected to the intermediate connecting element along a first elongated side that is wider than a width of the intermediate connecting element. The first elongated side may have a first portion overlapping a first side of the intermediate connecting element and a second portion overlapping a second side of the intermediate connecting element. A width of the first portion of the first elongated side may be shorter than a width of the second portion of the first elongated side.

In other preferred and non-limiting embodiments or aspects, the body of each of the first connector and the second connector may have at least one fixed buckle configured for receiving at least a portion of a harness webbing therethrough. The at least one fixed buckle may have a bar spaced apart from the body of each of the first connector and the second connector by a gap and a pair of posts connecting terminal ends of the bar to the body of each of the first connector and the second connector. The body of each of the first connector and the second connector may have at least one adjustable buckle configured for receiving at least a portion of a harness webbing therethrough. The adjustable buckle may have an adjustment mechanism configured for adjusting a position of at least one strap of the harness by selective frictional engagement with the at least one strap of the harness. The adjustment mechanism may have a frame connected at its terminal ends to the body of each of the first connector and the second connector with an opening between a central portion of the frame and the body of each of the first connector and the second connector. The adjustment mechanism further may have an adjustment bar extending across the opening and movably engaged with the terminal ends of the frame. The adjustment bar may have an elongated body with terminal ends curved in a direction toward one another. The frame may have a lifting tab configured as an arcuate bend in the frame. The body of at least one of the first connector and the second connector may be substantially planar. The connection arrangement may further have a relief opening extending through the body of at least one of the first connector and the second connector.

In other preferred and non-limiting embodiments or aspects, a wearable body harness having a plurality of straps may have a first shoulder strap and a second shoulder strap, a first connector on the first shoulder strap, and a second connector on the second shoulder strap. The first connector may have a body with a first portion of a locking mechanism, and the second connector may have a body with a second portion of the locking mechanism. The first shoulder strap and the second shoulder strap may be removably connectable to each other with engagement of the first connector and the second connector. The first portion of the locking mechanism may have a tab connected to the body of the first connector, and a slot having a first portion extending through the body of the first connector and a second portion extending through the tab. The second portion of the locking mechanism may have a tongue configured for being received through the first portion of the slot on the first connector, and an intermediate connecting element having a first end connected to the body of the second connector and a second end connected to the tongue. The second end of the intermediate connecting element may be receivable in the second portion of the slot on the tab.

In other preferred and non-limiting embodiments or aspects, the first shoulder strap may have a first portion connected to a first end of the first connector and a second portion connected to a second end of the first connector, and the second shoulder strap may have a first portion connected to a first end of the second connector and a second portion connected to a second end of the second connector. The first shoulder strap and the second shoulder strap may be arranged in an X-shaped configuration at a front portion of the harness.

Further preferred and non-limiting embodiments or aspects will now be set forth in the following numbered clauses.

Clause 1: A connection arrangement for use with a wearable body harness, the connection arrangement comprising: a first connector having a body with a first portion of a locking mechanism; and a second connector having a body with a second portion of the locking mechanism, wherein the first portion of the locking mechanism comprises: a tab connected to the body of the first connector and angled at a predetermined angle relative to a plane defined by the body, and a slot having a first portion extending through the body of the first connector and a second portion extending through the tab, and wherein the second portion of the locking mechanism comprises a tongue configured for being received through the first portion of the slot, and an intermediate connecting element having a first end connected to the body of the second connector and a second end connected to the tongue, the second end of the intermediate connecting element being offset from the body of the second connector such that the intermediate connecting element is receivable in the second portion of the slot on the tab.

Clause 2: The connection arrangement of clause 1, wherein the first portion of the locking mechanism is configured for interacting with the second portion of the locking mechanism to removably engage the first connector and the second connector between a first, locked configuration, where the first connector and the second connector are connected to each other, and a second, unlocked configuration, where the first connector and the second connector are disconnected from each other.

Clause 3: The connection arrangement of clause 1 or 2, wherein the predetermined angle is 30° to 180°.

Clause 4: The connection arrangement of any of clauses 1-3, wherein the first portion of the slot has an angled end surface that is angled at an angle of 90° to 180° relative to lateral surfaces of the first portion of the slot.

Clause 5: The connection arrangement of any of clauses 1-4, wherein a width of the first portion of the slot is narrower than a width of the tongue.

Clause 6: The connection arrangement of any of clauses 1-5, wherein a width of the second portion of the slot is wider than a width of the intermediate connecting element.

Clause 7: The connection arrangement of any of clauses 1-6, wherein the tongue is connected to the intermediate connecting element along a first elongated side that is wider than a width of the intermediate connecting element.

Clause 8: The connection arrangement of any of clauses 1-7, wherein the first elongated side has a first portion overlapping a first side of the intermediate connecting element and a second portion overlapping a second side of the intermediate connecting element.

Clause 9: The connection arrangement of any of clauses 1-8, wherein a width of the first portion of the first elongated side is shorter than a width of the second portion of the first elongated side.

Clause 10: The connection arrangement of any of clauses 1-9, wherein the body of each of the first connector and the second connector comprises at least one fixed buckle configured for receiving at least a portion of a harness webbing therethrough.

Clause 11: The connection arrangement of any of clauses 1-10, wherein the at least one fixed buckle has a bar spaced apart from the body of each of the first connector and the second connector by a gap and a pair of posts connecting terminal ends of the bar to the body of each of the first connector and the second connector.

Clause 12: The connection arrangement of any of clauses 1-11, wherein the body of each of the first connector and the second connector comprises at least one adjustable buckle configured for receiving at least a portion of a harness webbing therethrough, the adjustable buckle having an adjustment mechanism configured for adjusting a position of at least one strap of the harness by selective frictional engagement with the at least one strap of the harness.

Clause 13: The connection arrangement of any of clauses 1-12, wherein the adjustment mechanism comprises a frame connected at its terminal ends to the body of each of the first connector and the second connector with an opening between a central portion of the frame and the body of each of the first connector and the second connector, and an adjustment bar extending across the opening and movably engaged with the terminal ends of the frame.

Clause 14: The connection arrangement of any of clauses 1-13, wherein the adjustment bar has an elongated body with terminal ends curved in a direction toward one another.

Clause 15: The connection arrangement of any of clauses 1-14, wherein the frame has a lifting tab configured as an arcuate bend in the frame.

Clause 16: The connection arrangement of any of clauses 1-15, wherein the body of at least one of the first connector and the second connector is substantially planar.

Clause 17: The connection arrangement of any of clauses 1-16, further comprising a relief opening extending through the body of at least one of the first connector and the second connector.

Clause 18: A wearable body harness having a plurality of straps comprising: a first shoulder strap and a second shoulder strap; a first connector on the first shoulder strap, the first connector having a body with a first portion of a locking mechanism; and a second connector on the second shoulder strap, the second connector having a body with a second portion of the locking mechanism, wherein the first shoulder strap and the second shoulder strap are removably connectable to each other with engagement of the first connector and the second connector, and wherein the first portion of the locking mechanism comprises: a tab connected to the body of the first connector, and a slot having a first portion extending through the body of the first connector and a second portion extending through the tab, and wherein the second portion of the locking mechanism comprises: a tongue configured for being received through the first portion of the slot on the first connector, and an intermediate connecting element having a first end connected to the body of the second connector and a second end connected to the tongue, the second end of the intermediate connecting element being receivable in the second portion of the slot on the tab.

Clause 19: The wearable body harness of clause 18, wherein the first shoulder strap has a first portion connected to a first end of the first connector and a second portion connected to a second end of the first connector, and wherein the second shoulder strap has a first portion connected to a first end of the second connector and a second portion connected to a second end of the second connector.

Clause 20: The wearable body harness of clause 18 or 19, wherein the first shoulder strap and the second shoulder strap are arranged in an X-shaped configuration at a front portion of the harness.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 is a front perspective view of a wearable body harness in accordance with one preferred and non-limiting embodiment or aspect of the present invention;

FIG. 2A is a front perspective view of a harness connection arrangement for use with a wearable body harness in accordance with one preferred and non-limiting embodiment or aspect of the present invention showing a first connector and a second connector connected to each other;

FIG. 2B is a front perspective view of the harness connection arrangement of FIG. 2A showing the first connector and the second connector disconnected from each other;

FIG. 3A is a front view of the harness connection arrangement shown in FIG. 2A;

FIG. 3B is a rear view of the harness connection arrangement shown in FIG. 2A;

FIG. 3C is a side view of the harness connection arrangement shown in FIG. 2A;

FIG. 4A is a front perspective view of a first connector of the harness connection arrangement of FIGS. 2A-2B;

FIG. 4B is a front view of the first connector shown in FIG. 4A;

FIG. 4C is a side view of the first connector shown in FIG. 4A;

FIG. 5A is a front perspective view of a second connector of the harness connection arrangement of FIGS. 2A-2B;

FIG. 5B is a front view of the second connector shown in FIG. 5A;

FIG. 5C is a side view of the second connector shown in FIG. 5A;

FIG. 6A is a front perspective view of an adjustment bar of the harness connection arrangement of FIGS. 2A-2B;

FIG. 6B is a side view of the adjustment bar shown in FIG. 6A;

FIG. 6C, is a side perspective view of strap routing through an adjustment bar; and

FIGS. 7A-7E are various front perspective views of the harness connection arrangement as the first connector and the second connector as disconnected from each other.

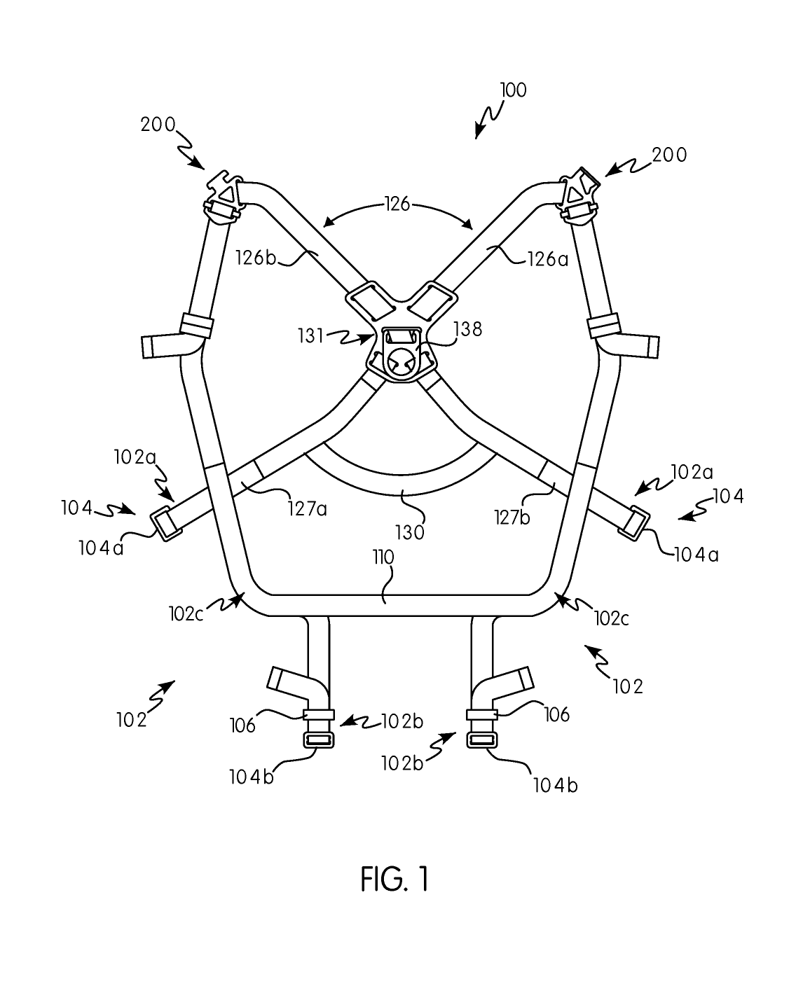

In FIGS. 1-7E, like characters refer to the same components and elements, as the case may be, unless otherwise stated.

### DETAILED DESCRIPTION OF THE INVENTION

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the invention as shown in the drawing figures and are not to be considered as limiting as the invention can assume various alternative orientations.

All numbers and ranges used in the specification and claims are to be understood as being modified in all instances by the term “about”. By “about” is meant plus or minus twenty-five percent of the stated value, such as plus or minus ten percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

The term “at least” is synonymous with “greater than or equal to”.

The term “not greater than” is synonymous with “less than or equal to”.

As used herein, “at least one of” is synonymous with “one or more of”. For example, the phrase “at least one of A, B, and C” means any one of A, B, or C, or any combination of any two or more of A, B, or C. For example, “at least one of A, B, and C” includes A alone; or B alone; or C alone; or A and B; or A and C; or B and C; or all of A, B, and C.

The term “adjacent” means proximate to but not in direct contact with.

The term “includes” is synonymous with “comprises”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular” or “substantially perpendicular” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

The discussion of the invention may describe certain features as being “particularly” or “preferably” within certain limitations (e.g., “preferably”, “more preferably”, or “even more preferably”, within certain limitations). It is to be understood that the invention is not limited to these particular or preferred limitations but encompasses the entire scope of the disclosure.

In various non-limiting embodiments or aspects, and with reference to FIG. 1, the present disclosure is directed to a safety harness 100 (hereinafter referred to as “harness 100”) used in a fall protection system. As discussed herein, the harness 100 has a harness connection arrangement configured for releasably coupling at least a pair of straps of the harness 100. Preferably, the harness 100 has a harness connection arrangement for connecting at least two straps of the harness, wherein the harness connection arrangement can be easily and effectively connected and disconnected to allow quick donning and removal of the harness 100.

With continued reference to FIG. 1, the harness 100 has at least two leg straps 102 configured to attach around a user's legs below a user's groin area. When attached, the leg straps 102 loop around or encircle each of the user's legs. Each leg strap 102 has a first end 102a that is removably attachable to a second end 102b via a connector 104. In some non-limiting embodiments or aspects, the connector 104 may be a clip, a buckle, a mating arrangement, an actuatable structure, or the like. The connector 104 permits removable attachment of the first end 102a to the second end 102b of each leg strap 102. In this manner, the first and second ends 102a, 102b of the leg straps 102 are configured to be removably attached to each other and configured to be free floating when detached from each other. In some non-limiting embodiments or aspects, at least one connector 104 and/or the leg strap 102 may have at least one connection mechanism 106 configured for adjusting the length of each leg strap 102. In this manner, the at least one connection mechanism 106 adjusts a distance between the first end 102a and the second end 102b such that each leg strap 102 may be adjusted to fit comfortably around the user's legs. Each leg strap 102 may be formed from a substantially flat webbing material typically used in harness construction. One or more handles, clips, and/or connectors (not shown) may be provided on at least a portion of the harness 100. The harness 100 may include padding (not shown) for increasing the user's comfort while wearing the harness 100.

In various non-limiting embodiments or aspects, the leg straps 102 (or, indeed, any of the straps in the harness 100) may be linear lengths of material, folded straps that form loops with the at least one connector 104 at the first end 102a and/or the second end 102b, or the like. For example, as shown in FIG. 1, the connector 104 may have a first portion 104b that is adjustably attached to the first end 102b of at least one leg strap 102 through a loop of the material that makes up the leg strap 102, while a second portion 104a of the connector 104 is non-adjustably secured at the second end 102a of at least one leg strap 102. Therefore, in such an arrangement, the first portion 104b of the connector 104 and the loop of material that makes up the leg strap 102 at the second end 102b defines the at least one connection mechanism 106 for adjusting a length of the leg strap 102. It should be noted that the position of the connection mechanism 106 may be reversed such that the second portion 104a of the connector 104 is provided on the first end 102b of the leg strap 102. At least one leg strap 102 may include padding (not shown) for increasing the user's comfort while wearing the harness 100.

With continued reference to FIG. 1, each leg strap 102 is connected to a seat strap 110 at a substantially intermediate portion 102c of the leg strap 102 between the first end 102a and the second end 102b. In some non-limiting embodiments or aspects, the substantially intermediate portion 102c of the leg strap 102 may be directly and non-movably connected to a seat strap 110, such as being sewn directly to the seat strap 110. In other non-limiting embodiments or aspects, the substantially intermediate portion 102c of each leg strap 102 may be connected to the rear end of the seat strap 110 by a connection strap (not shown) to allow the substantially intermediate portion 102c of the leg strap 102 to slidably move along a front portion of the leg strap 102. Accordingly, the position of the leg straps 102 may be adjusted relative to the seat strap 110 to increase the user's comfort while wearing the harness 100.

With continued reference to FIG. 1, the harness 100 further has the shoulder strap 126 configured to extend over at least a portion of the user's shoulders. The shoulder strap 126 may have a first shoulder strap 126a and a second shoulder strap 126b arranged to overlap one another in an X-shaped configuration. In some non-limiting embodiments or aspects, the shoulder strap 126 may have at least one shoulder pad 131 having one or more openings through which the first shoulder strap 126a and the second shoulder strap 126b can be arranged to maintain the first shoulder strap 126a and the second shoulder strap 126b in the X-shaped configuration.

As further shown in FIG. 1, the first shoulder strap 126a has a first end 127a that is connected to the first end 102a of a first leg strap 102. The first end 127a of the first shoulder strap 126a may be removably or non-removably attachable to the first end 102a of a first leg strap 102. In some non-limiting embodiments or aspects, the first end 127a of the first shoulder strap 126a may be attached to the first end 102a of a first leg strap 102 via a connector similar to the connector 104 described herein with reference to the leg straps 102. At least a portion of the first shoulder strap 126a may be formed from a substantially flat webbing material typically used in harness construction.

With continued reference to FIG. 1, the second shoulder strap 126b has a first end 127b that is connected to the first end 102a of the second leg strap 102. The first end 127b of the second shoulder strap 126b may be removably or non-removably attachable to the first end 102a of the second leg strap 102. In some embodiments or aspects, the first end 127b of the second shoulder strap 126b may be attached to the first end 102a of the second leg strap 102 via a connector similar to the connector 104 described herein with reference to the leg straps 102. At least a portion of the second shoulder strap 126b may be formed from a substantially flat webbing material typically used in harness construction.

As further shown in FIG. 1, the harness 100 may have a back strap 130 connecting a substantially intermediate portion of the first shoulder strap 126a between its first end 127a with a substantially intermediate portion of the second shoulder strap 126b between its first end 127b. In some non-limiting embodiments or aspects, a position of the back strap 130 may be fixed relative to the shoulder straps 126a, 126b. In other non-limiting embodiments or aspects, a position of the back strap 130 may be adjustable along a longitudinal direction of the first shoulder strap 126a and the second shoulder strap 126b, such as by sliding the back strap 130 along the first shoulder strap 126a and/or the second shoulder strap 126b.

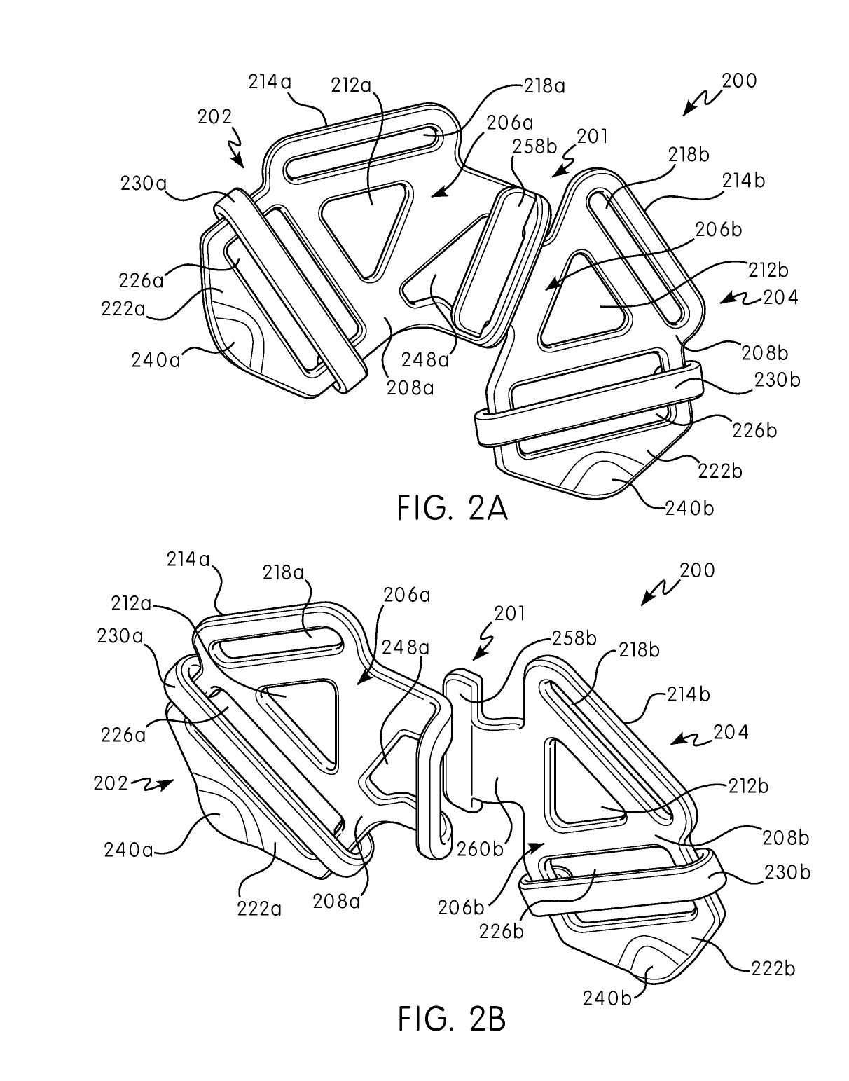

With continued reference to FIG. 1, the first and second shoulder straps 126a, 126b may be connectable together at a front portion of the harness 100 in an area of the user's chest. In some non-limiting embodiments or aspects, the first and second shoulder straps 126a, 126b may have at least one connection arrangement 200 further described herein with reference to FIGS. 2A-6B.

As further shown in FIG. 1, the shoulder strap 126 has an anchor element, such as a D-ring 138, for connecting at least a portion of the shoulder strap 126 to a line connected to an anchor point. In some non-limiting embodiments or aspects, at least a portion of the first shoulder strap 126a and the second shoulder strap 126b is looped around or otherwise permanently attached to the D-ring 138. The D-ring 138 has a frame defining at least one opening through which the first shoulder strap 126a and the second shoulder strap 126b may be looped around and through which a clip, such as a carabiner, a lanyard, or other rope or line, can be secured to connect the harness 100 to an anchor point.

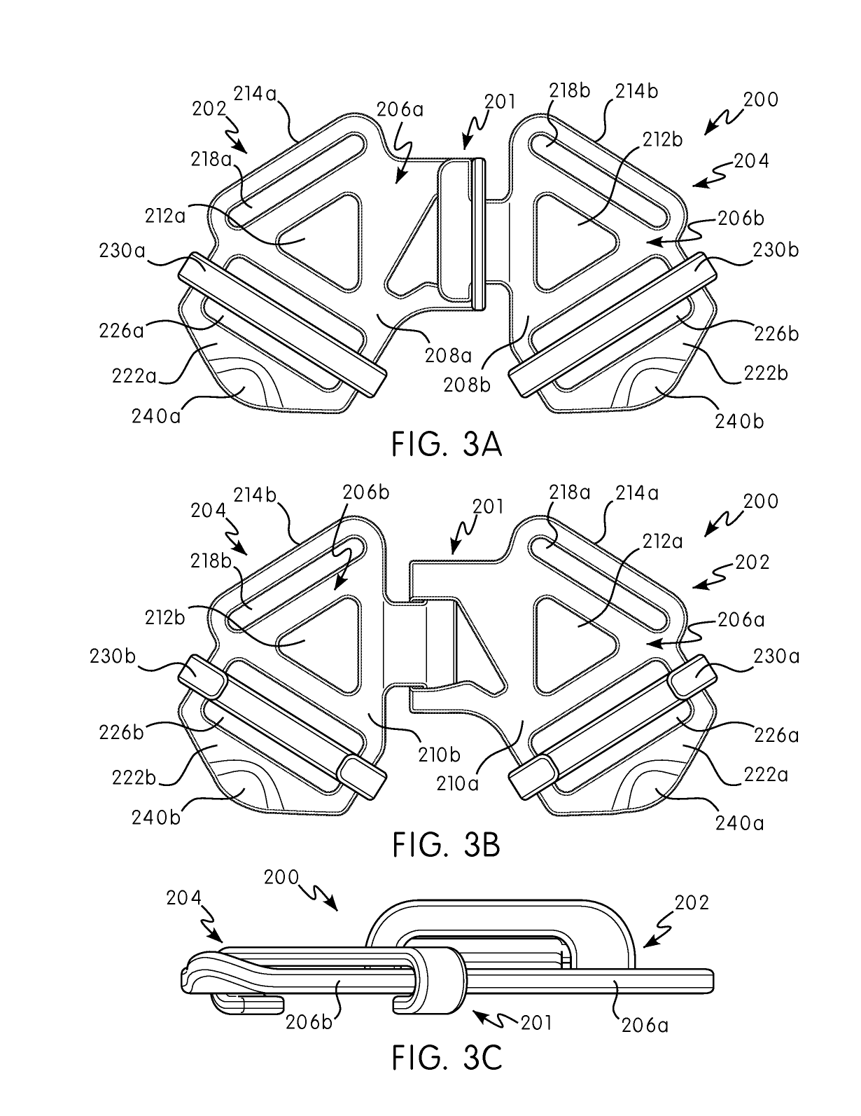

With reference to FIGS. 2A-3C, the connection arrangement 200 for use with a wearable body harness, such as the harness 100 shown in FIG. 1, is shown in accordance with one preferred and non-limiting embodiment or aspect of the present invention. The connection arrangement 200 is illustrated without harness straps for clarity. While in some preferred and non-limiting embodiments or aspects of the present invention the connection arrangement 200 is configured for connecting portions of the shoulder strap 126 across the user's chest, the connection arrangement 200 can be used to connect any two or more straps of the harness 100.

With continued reference to FIGS. 2A-3C, the connection arrangement 200 has a first connector 202 removably connectable to a second connector 204. As described herein, the first and second connectors 202, 204 are engageable between a first, locked configuration, where the first and second connectors 202, 204 are connected to each other, and a second, unlocked configuration, where the first and second connectors 202, 204 are disconnected from each other. The first and second connectors 202, 204 can be connected to one another by actuating a locking mechanism, such as a tongue and clasp arrangement discussed herein. In various preferred and non-limiting embodiments or aspects, the connection arrangement 200 may be made from metal, plastic, a composite material, and any combination thereof.

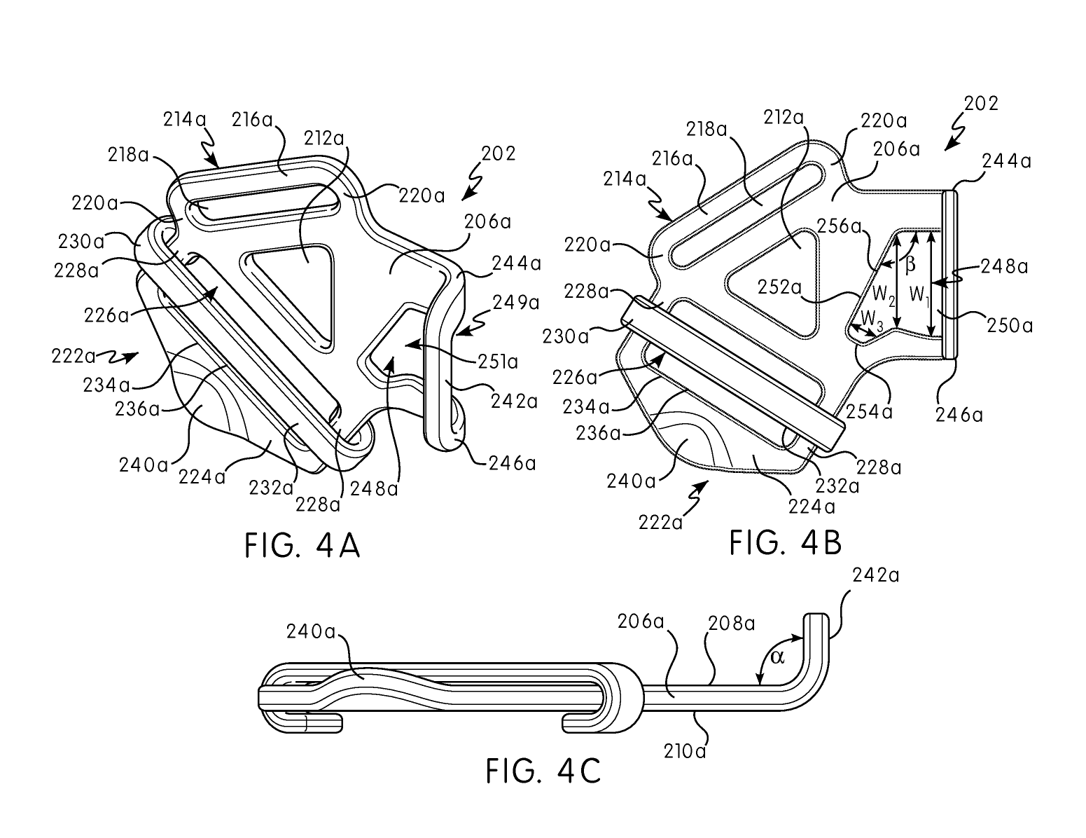

With reference to FIGS. 4A-4C, the first connector 202 is shown separate from the second connector 204 of the connection arrangement 200. The first connector 202 has a body 206a with a first side 208a opposite a second side 210a (shown in FIG. 4C). In some preferred and non-limiting embodiments or aspects, the first side 208a may face away from a body of the user while a second side 210a may face toward a body of the user when the first connector 202 is installed on a harness worn by the user. While FIGS. 4A-4C show the body 206a of the first connector 202 being substantially planar, the body 206a may have a non-planar shape in other preferred and non-limiting embodiments or aspects. The body 206a may be monolithically formed as a single, integral piece. In other preferred and non-limiting embodiments or aspects, the body 206a of the first connector 202 may be formed from two or more components that are removably or non-removably connected together. In various preferred and non-limiting embodiments or aspects, the body 206a of the first connector 202 may be made from metal, plastic, a composite material, and any combination thereof.

With reference to FIGS. 4A-4B, the body 206a of the first connector 202 has a substantially triangular shape. In other preferred and non-limiting embodiments or aspects, the body 206a may have any other shape, such as a circular shape, an oval shape, a rectangular shape, or any other regular or irregular geometric shape. In preferred and non-limiting embodiments or aspects, a relief opening 212a may be provided on the body 206a to reduce the weight of the first connector 202a. The relief opening 212a desirably extends through the body 206a between the first side 208a and the second side 210a. In some preferred and non-limiting embodiments or aspects, the relief opening 212a may be formed as a recess that is partially recessed into one or both of the first side 208a and the second side 210a of the body 206a. The relief opening 212a may be shaped to correspond to the shape of the body 206a. For example, in a body 206a having a substantially triangular shape, the relief opening 212a may have a corresponding substantially triangular shape. In some preferred and non-limiting embodiments or aspects, the relief opening 212a may have a shape that is different than the shape of the body 206a of the first connector 202. The relief opening 212a may be centered on the body 206a or offset toward any side of the body 206a.

With reference to FIGS. 4A-4B, the first connector 202 has at least one fixed buckle 214a connected to the body 206a. In some preferred and non-limiting embodiments or aspects, the at least one fixed buckle 214a may be connected to one of the three sides of the body 206a having a substantially triangular shape. The fixed buckle 214a is configured for receiving at least a portion of a harness webbing therethrough, such as at least a portion of the shoulder harness 126 and/or the chest strap 132. The fixed buckle 214a may have a bar 216a that is spaced apart from the body 206a of the first connector 202 such that the harness webbing may be inserted through a gap 218a formed between the bar 216a and the body 206a. The bar 216a is connected to the body 206a by posts 220a. The webbing is desirably looped through the gap 218a and around the bar 216a such that the webbing overlaps itself around the bar 216a. The overlapping ends of the webbing may be sewn together or otherwise attached to prevent removal of the webbing from the fixed buckle 214a.

In some preferred and non-limiting embodiments or aspects, the at least one fixed buckle 214a may be provided on an upper side and/or a lower side of the first connector 202 when the harness 100 (shown in FIG. 1) is worn by a user. In this manner, one or more straps may be connected to the at least one fixed buckle 216a from above or below the first connector 202. In FIGS. 4A-4B, the at least one fixed buckle 214a is provided on an upper side of the first connector 202 when the harness 100 is worn by the user.

With continued reference to FIGS. 4A-4B, the first connector 202 has at least one adjustable buckle 222a connected to the body 206a. In some preferred and non-limiting embodiments or aspects, the at least one adjustable buckle 222a may be connected to one of the three sides of the body 206a having a substantially triangular shape. The at least one adjustable buckle 222a is configured for receiving at least a portion of a harness webbing therethrough, such as at least a portion of the shoulder harness 126 (shown in FIG. 1). In some preferred and non-limiting embodiments or aspects, the at least one adjustable buckle 222a has an adjustment mechanism associated therewith to permit an adjustment of at least one strap of the harness 100 (shown in FIG. 1) that is connected to the at least one adjustable buckle 222a. The adjustment mechanism may be configured for permitting frictional adjustment of the at least one strap of the harness 100, as described herein.

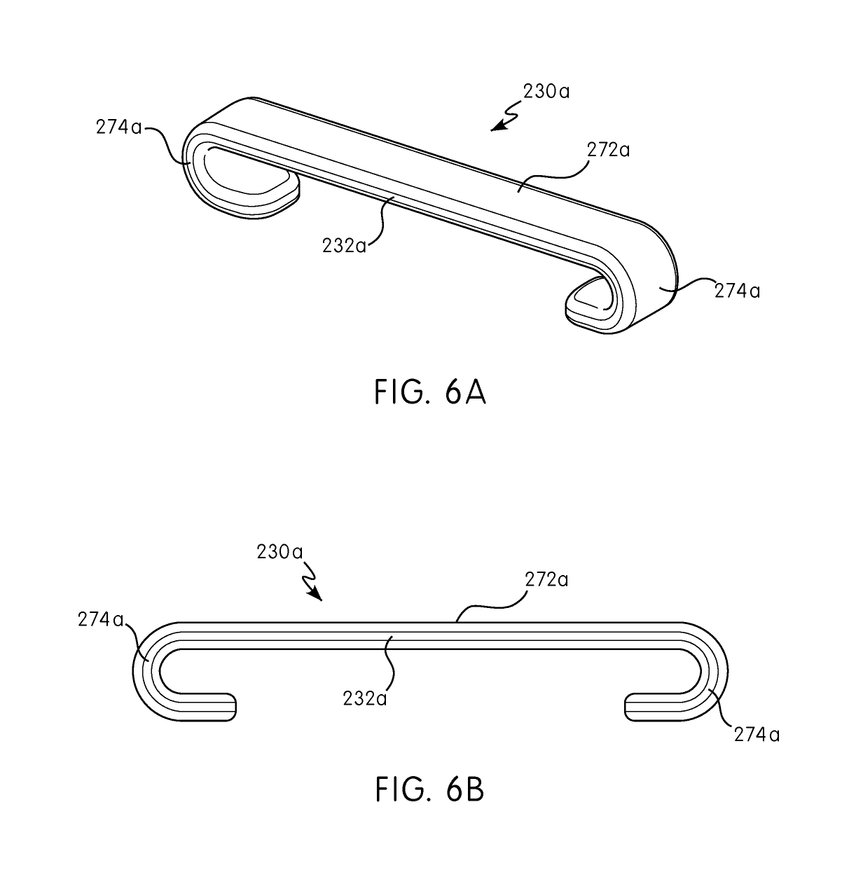

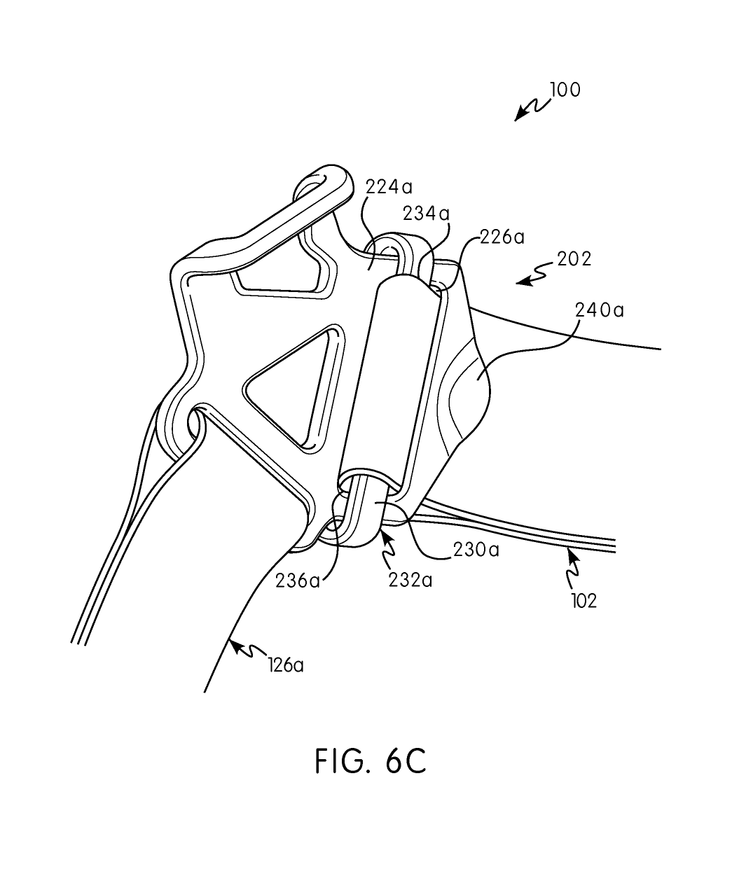

With continued reference to FIGS. 4A-4B, the at least one adjustable buckle 222a may have a frame 224a that is spaced apart from the body 206a of the first connector 202 such that at least one strap of the harness 100 (shown in FIG. 1) may be inserted through an opening 226a formed between the frame 224a and the body 206a. The frame 224a is connected to the body 206a at its terminal ends 228a. The at least one adjustable buckle 222a further has an adjustment bar 230a configured to permit adjustable movement of at least one strap of the harness 100. The adjustment bar 230a extends across the opening 226a and is moveably engaged with the adjustable buckle 222a, such as by sliding contact with the terminal ends 228a of the frame 224a. The adjustment bar 230a is movable across the opening 226a between a first position closer to the body 206a of the first connector 202 and a second position further away from the body 206a. With reference to FIGS. 6A-6B, the adjustment bar 230a has an elongated body 272a with terminal ends 274a that are bent in a direction toward one another. The terminal ends 274a may be bent away from the body 274a in an arcuate shape.

In use, and with reference to FIG. 6C, at least one strap 102 of the harness 100 is looped around the adjustment bar 230a and through the opening 226a. The adjustment bar 230a has a first contact surface 232a to contact a first surface of at least one strap 102 of the harness 100, while a first end 234a of the frame 224a has a second contact surface 236a to contact a second surface opposite the first surface of the at least one strap 102 of the harness 100 such that the at least one strap 102 is wedged between the first contact surface 232a and the second contact surface 236a when the adjustment bar 230a is in the second position. The frictional contact between the at least one strap and the first contact surface 232a and the second contact surface 236a prevents the strap from moving relative to the first connector 202. The first end 234a of the frame 224a has a lifting tab 240a configured to permit the user to grasp the first end 234a of the frame 224a and move it relative to the body of the user, such as in a direction up and away from the user's body. In some preferred and non-limiting embodiments or aspects, the lifting tab 240a may be formed as an arcuate bend in the frame 224a that is configured for being grasped by the user's fingers. Movement of the frame 224 due to engagement of the lifting tab 240a by the user's fingers changes an angle of at least one strap relative to the first contact surface 232a and the second contact surface 236a to allow the adjustment bar 230a to be moved to the first position, thereby allowing the at least one strap to movably adjust relative to the first connector 202.

In some preferred and non-limiting embodiments or aspects, the at least one adjustable buckle 222a may be provided on an upper side and/or a lower side of the first connectors 202 when the harness 100 (shown in FIG. 1) is worn by a user. In this manner, one or more straps may be connected to the at least one fixed buckle 216a from above or below the first connector 202. In FIGS. 4A-4B, the at least one adjustable buckle 222a is provided on a lower side of the first connector 202 when the harness 100 is worn by the user.

With continued reference to FIGS. 4A-4B, the first connector 202 has a first portion of a locking mechanism 201 (shown in FIGS. 2A-2B) configured for engaging the first connector 202 between the first, locked configuration, where the first connector 202 is connected to the second connector 204 (shown in FIGS. 3A-3B) and a second, unlocked configuration, where the first connector 202 is disconnected from the second connector 204. The first connector 202 has a tab 242a that is connected to the body 206a and is angled relative to a main plane of the body 206a. The tab 242a may be monolithically formed with the body 206a of the first connector 202, or may be removably or non-removably attached to the body 206a. In some preferred and non-limiting embodiments or aspects, the tab 242a may be angled at a substantially perpendicular angle relative to the main plane of the body 206a defined, for example, by at least one of the first side 208a and the second side 210a of the body 206a. In other preferred and non-limiting embodiments or aspects, the tab 242a may be angled at an angle α (shown in FIG. 4C) relative to the main plane of the body 206a. Angle α may be between 30° to 180°, preferably between 45° to 165°, more preferably between 60° to 150°, more preferably between 75° to 135°, and more preferably between 85° to 120°, such as approximately 90°.

With continued reference to FIGS. 4A-4B, the tab 242a has a first end 244a and a second end 246a connected to the body 206a. A slot 248a has a first portion 249a that extends through at least a portion of the body 206a between the first side 208a and the second side 210a. The slot 248a further has a second portion 251a that extends through the tab 242a between the first end 244a and the second end 246a. Together, the first portion 249a and the second portion 251a of the slot 248a define the first portion of the locking mechanism 201 (shown in FIGS. 2A-2B) and are shaped to receive a corresponding tongue on the second connector 204, as described herein. In some preferred and non-limiting embodiments or aspects, the first portion 249a of the slot 248a has a first end 250a opposite a second end 252a. The first end 250a may have a substantially uniform width W₁. The second end 252a of the first portion 249a of the slot 248a has a width W₂ that narrows in a direction away from the tab 242a and toward the body 206a. The “ramp” between W₁ and W₂ of the slot 248a may have a substantially constant width as the second connector 204 is rotated during disassembly so that the tongue of the second connector 204 is not accidentally removed from the slot 248a before the tongue is moved to the second end 252a.

In some preferred and non-limiting embodiments or aspects, the second end 252a of the first portion 249a of the slot 248a may be angled at an angle β relative to a side surface of the first portion 249a. The second end 252a of the first portion 249a of the slot 248a further has a notch 254a at a terminal end thereof. The notch 254a is shaped and sized to receive a corresponding portion of the tongue of the second connector 204, as described herein. An angled surface 256a of the notch 254a has a width W₃ that is narrower than a width of the widest portion of the tongue of the second connector 204, as described herein. The angled surface 256a is angled to prevent accidental disassembly of the connection arrangement 200.

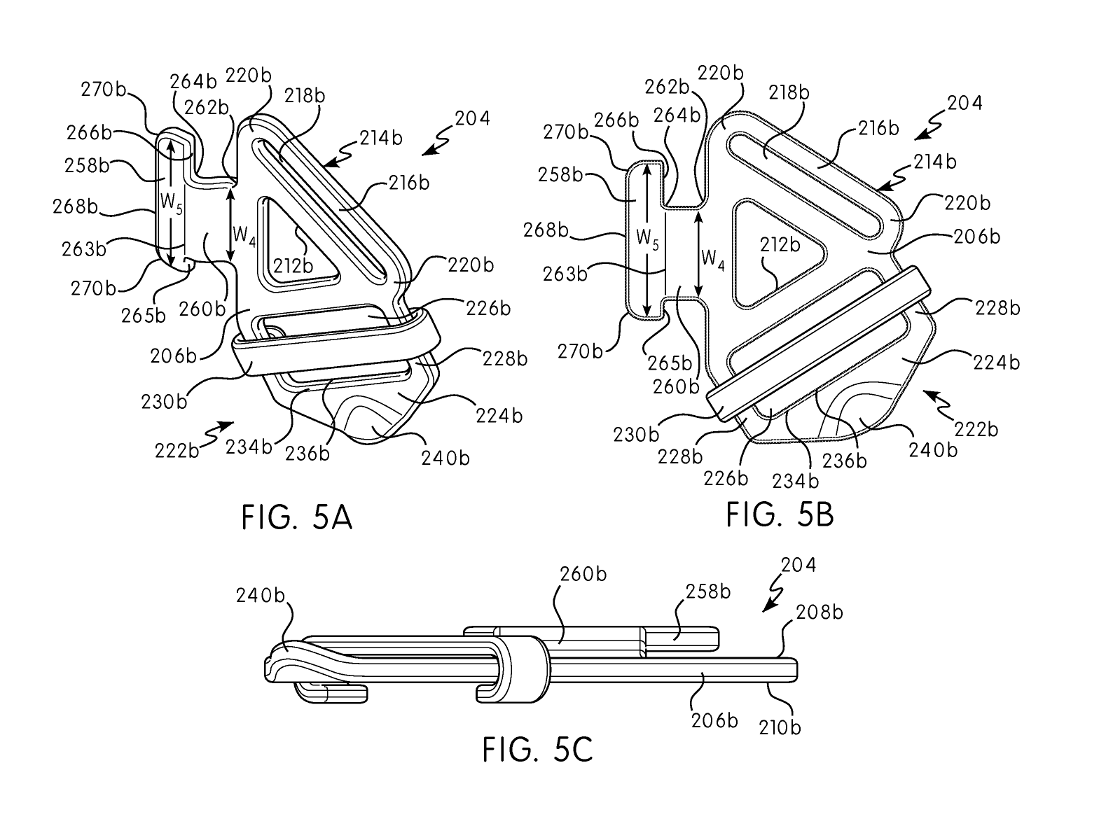

With reference to FIGS. 5A-5C, the second connector 204 is shown separate from the first connector 202 of the connection arrangement 200. Components of the second connector 204 shown in FIGS. 5A-5C are substantially similar or identical to the components of the first connector 202 described herein with reference to FIGS. 4A-4C. Reference numerals in FIGS. 5A-5C are used to illustrate identical components of the corresponding reference numerals in FIGS. 4A-4C, with the exception of an identifier “a” being replaced with an identifier “b”. For example, whereas the body of the first connector 202 is identified with reference numeral 206a, the body of the second connector 204 is identified with reference numeral 206b. As the previous discussion regarding the first connector 202 generally shown in FIGS. 4A-4C is applicable to the second connector 204 shown in FIGS. 5A-5C, only the relative differences between the first and second connectors 202, 204 are discussed hereinafter.

With continued reference to FIGS. 5A-5C, the second connector 204 is shown separate from the first connector 202 of the connection arrangement 200. As described herein, the first and second connectors 202, 204 are engageable between a first, locked configuration, where the first and second connectors 202, 204 are connected to each other, and a second, unlocked configuration, where the first and second connectors 202, 204 are disconnected from each other. The first and second connectors 202, 204 can be connected to one another by actuating the locking mechanism, such as the tongue and slot arrangement discussed herein.

With continued reference to FIGS. 5A-5C, the second connector 204 has a body 206b with a first side 208b opposite a second side 210b. In some preferred and non-limiting embodiments or aspects, the first side 208b may face away from a body of the user while a second side 210b may face toward a body of the user when the second connector 204 is installed on a harness worn by the user. While FIGS. 5A-5C show the body 206b of the second connector 204 being substantially planar, the body 206b may have a non-planar shape. In some preferred and non-limiting embodiments or aspects, the body 206b may have a shape that corresponds to the shape of the body 206a of the first connector 202. For example, the body 206b of the second connector 204 may be a mirror image of the body 206a of the first connector 202.

With continued reference to FIGS. 5A-5C, the second connector 204 has a second portion of the locking mechanism 201 (shown in FIGS. 2A-2B) configured for engaging with the first portion of the locking mechanism 201 on the first connector 202 between the first, locked configuration, where the first connector 202 is connected to the second connector 204 (shown in FIG. 2A) and a second, unlocked configuration, where the first connector 202 is disconnected from the second connector 204 (shown in FIG. 2B). In some preferred and non-limiting embodiments or examples, the second portion of the locking mechanism 201 may be defined by a tongue 258b connected to the body 206b by an intermediate connecting element 260b. The tongue 258b may be offset from a plane defined by the body 206b by the intermediate connecting element 260b. For example, the intermediate connecting element 260b may have a first end 262b connected to the body 206b and a second end 264b opposite the first end 262b, wherein the second end 264b is in an offset plane relative to the first end 262b. In some preferred and non-limiting embodiments or aspects, the intermediate connecting element 260b may have an S-shape, an L-shape, or other geometric shape wherein one side thereof is in an offset plane relative to another side thereof. In some preferred and non-limiting embodiments or aspects, the second end 264b of the intermediate connecting element 260b is offset from the body 206b such that the tongue 258b is aligned with the first portion 250a of the slot 248a on the first connector 202 when the first connector 202 and the second connector 204 are connected together in a locked configuration.

A width W₄ of the intermediate connecting element 260b may be substantially uniform along its length. The width W₄ of the intermediate connecting element 260b is narrower than the width W₁ of the first end 250a of the first portion 249a of the slot 248a (shown in FIGS. 4A-4B) such that the intermediate connecting element 260b may be received within the first end 250a of the slot 248a when the first connector 202 and the second connector 204 are connected together.

With continued reference to FIGS. 5A-5C, the tongue 258b is connected to the intermediate connecting element 260b at a first elongated side 263b. In some preferred and non-limiting embodiments or aspects, a width W₅ of the first elongated side 263b may be wider than the width W₄ of the intermediate connecting element 260b such that the first elongated side 263b of the tongue 258b has at least a portion that overlaps the intermediate connecting element 260b. The first elongated side 263b of the tongue 258b may be positioned relative to the intermediate connecting element 260b such that it overlaps the intermediate connecting element 260b on both sides of the intermediate connecting element 260b. In some preferred and non-limiting embodiments or aspects, the first elongated side 263b of the tongue 258b may have a first portion 265b on a first side of the intermediate connecting element 260b and a second portion 266b on a second side of the intermediate connecting element 260b. A width of the first portion 265b of the first elongated side 263b may be shorter than a width of the second portion 266b of the first elongated side 263b so that the second portion 266b cannot be removed through the second end 252a of the first connector 202 before the first portion 265b is removed. The natural tendency of this connection is to separate with the second portion 266b coming out first. To reduce accidental separation, the second portion 266b can be made wider than the first portion 265a so that the second portion 266b cannot come out first. In some preferred and non-limiting embodiments or aspects, the width of the first and second portions 265b, 266b of the first elongated side 263b may be the same.

With continued reference to FIGS. 5A-5C, the tongue 258b has a second elongated side 268b opposite the first elongated side 263b. A width of the second elongated side 268b may be substantially identical to the width W₅ of the first elongated side 263b. In some preferred and non-limiting embodiments or aspects, the second elongated side 268b has at least one rounded corner, such as a pair of rounded corners 270b. In some preferred and non-limiting embodiments or aspects, the overall width of the tongue 258b is wider than the width W₃ of the angled surface 256a of the notch 254a on the first connector 202 (shown in FIGS. 4A-4B) such that the tongue 258b can only be inserted into and removed from the slot 248a by moving the tongue 258b at an angle relative to the slot 248a.

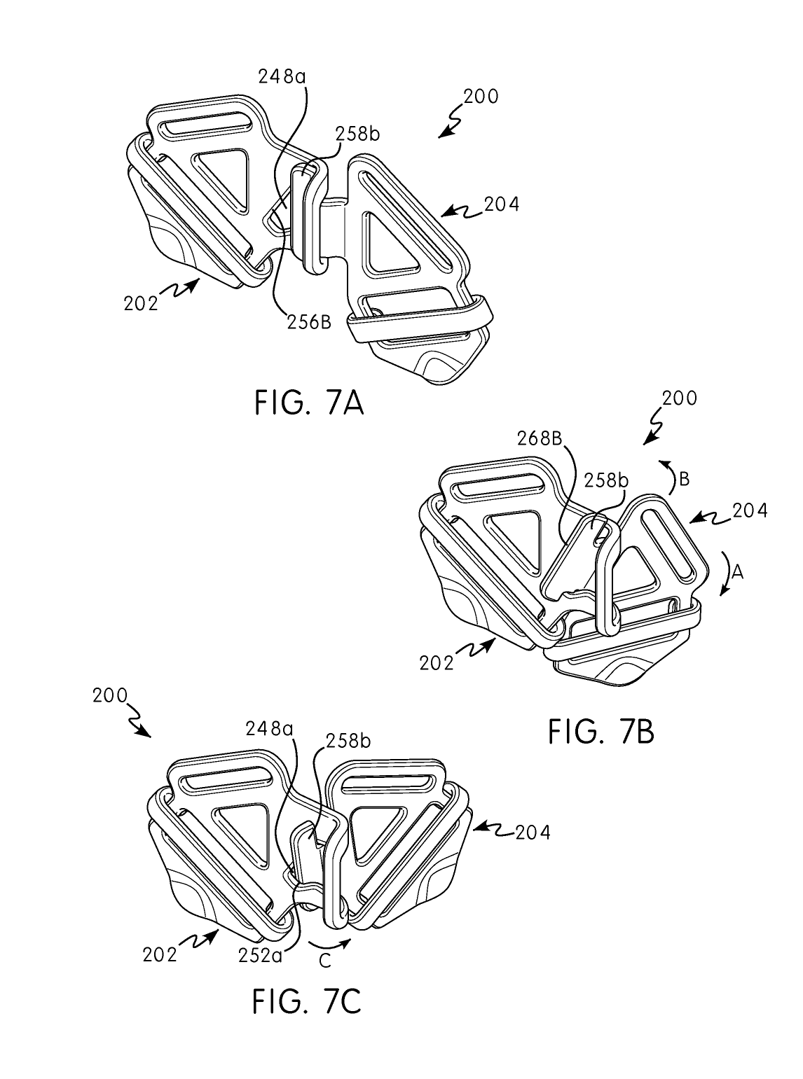

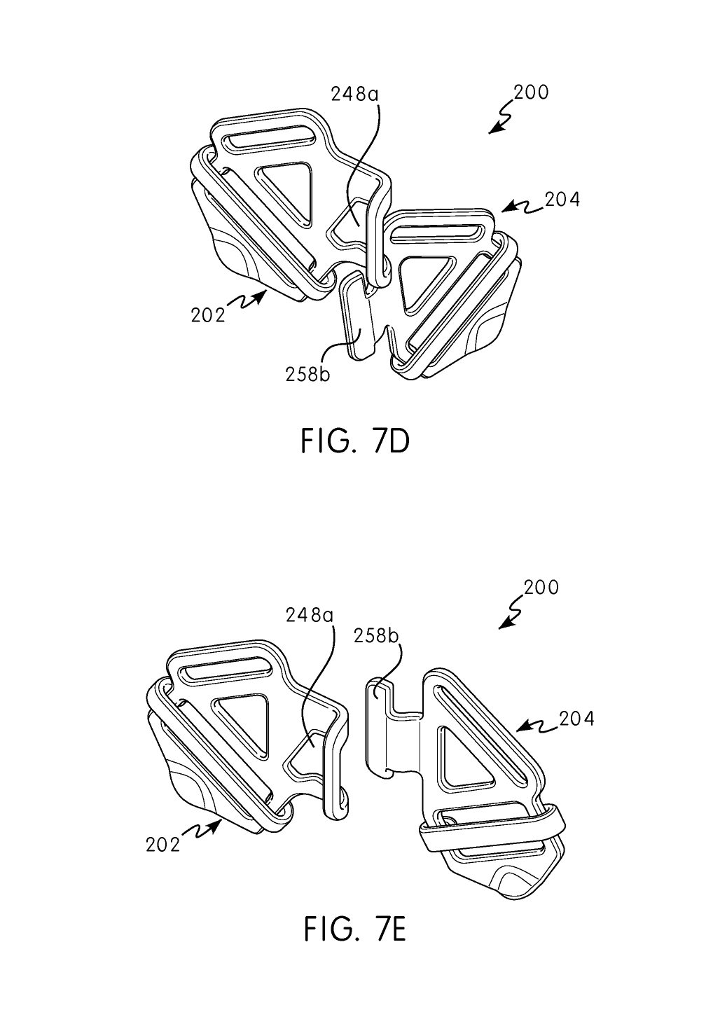

Having described the structure of the connection arrangement 200 with reference to FIGS. 4A-5C, a method of connecting the first connector 202 to the second connector 204 and disconnecting the first connector 202 from the second connector 204 will now be described with reference to FIGS. 7A-7E. Referring initially to FIG. 7A, the connection arrangement 200 is shown in a locked configuration, where the first and second connectors 202, 204 are connected to each other. While straps of the harness 100 (shown in FIG. 1) are omitted from FIGS. 7A-7E for clarity, when the first and second connectors 202, 204 are in the unlocked configuration, at least two straps of the harness 100, such as the shoulder straps 126, are disconnected from each other to allow for putting on or removing the harness 100 from the user's body. As described herein, the first and second connectors 202, 204 can be disconnected from each other by rotating the connectors 202, 204 relative to one another in a direction of arrow A about the planes defined by the bodies of the first and second connectors 202, 204. The second connector 204 is then rotated in a direction of arrow B relative to the first connector 202 such that the plane defined by the body 206b of the second connector 204 is angled relative to the plane defined by the body 206a of the first connector 202 until the second elongated side 268b of the tongue 258b on the second connector 204 is substantially parallel with the angled surface 256a on the slot 248a of the first connector 202 (FIG. 7B). This allows the tongue 258a to be removed through the second end 252a of the slot 248a to disconnect the second connector 204 from the first connector 202 (FIG. 7C). The first connector 202 can then be freely removed from the second connector 204 (FIGS. 7D-7E).

To connect the first connector 202 to the second connector 204, the tongue 258b and the intermediate connecting element 260b of the second connector 204 are inserted into the slot 248a in the first connector 202 by, for example, positioning the first connector 202 relative to the second connector 204 as shown in FIG. 7C. In some preferred and non-limiting embodiments or aspects, the first and second connectors 202, 204 can be aligned in such manner by, for example, rotating one or both of the first and second connectors 202, 204 until the second elongated side 268b of the tongue 258b on the second connector 204 is substantially parallel with the angled surface 256a on the slot 248a of the first connector 202. Because the tongue 258b is wider than the width of the slot 248a, the tongue 258b cannot be inserted into the slot 248a without rotating the second connector 204 such that the plane defined by the body 206b of the second connector 204 is angled relative to the plane defined by the body 206a of the first connector 202 (FIG. 7B). This allows the tongue 258b to be inserted into the second end 252a of the slot 248a. Upon insertion of a first portion of the tongue 258b, the second portion of the tongue 258b is rotated to also insert the second portion of the tongue 258b into the slot 248a (FIG. 7A). The first and second connectors 202, 204 are then connected together such that the tongue 258b cannot be removed from the slot 248b without deliberately aligning the first and second connectors 202, 204 as described herein.

Although the invention has been described in detail for the purpose of illustration based on what are currently considered to be the most practical, preferred, and non-limiting embodiments or aspects, it is to be understood that such detail is solely for that purpose and that the invention is not limited to the disclosed embodiments or aspects, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A connection arrangement for use with a wearable body harness, the connection arrangement comprising:
a first connector having a body with a first portion of a locking mechanism; and
a second connector having a body with a second portion of the locking mechanism,
wherein the first portion of the locking mechanism comprises:
a tab connected to the body of the first connector and angled at a predetermined angle relative to a plane defined by the body, and
a slot having a first portion extending through the body of the first connector and a second portion extending through the tab, and
wherein the second portion of the locking mechanism comprises:
a tongue configured for being received through the first portion of the slot, and
an intermediate connecting element having a first end connected to the body of the second connector and a second end connected to the tongue, the second end of the intermediate connecting element being offset from the body of the second connector such that the intermediate connecting element is receivable in the second portion of the slot on the tab.

2. The connection arrangement of claim 1, wherein the first portion of the locking mechanism is configured for interacting with the second portion of the locking mechanism to removably engage the first connector and the second connector between a first, locked configuration, where the first connector and the second connector are connected to each other, and a second, unlocked configuration, where the first connector and the second connector are disconnected from each other.

3. The connection arrangement of claim 1, wherein the predetermined angle is 30° to 180°.

4. The connection arrangement of claim 1, wherein the first portion of the slot has an angled end surface that is angled at an angle of 90° to 180° relative to lateral surfaces of the first portion of the slot.

5. The connection arrangement of claim 1, wherein a width of the first portion of the slot is narrower than a width of the tongue.

6. The connection arrangement of claim 1, wherein a width of the second portion of the slot is wider than a width of the intermediate connecting element.

7. The connection arrangement of claim 1, wherein the tongue is connected to the intermediate connecting element along a first elongated side that is wider than a width of the intermediate connecting element.

8. The connection arrangement of claim 7, wherein the first elongated side has a first portion overlapping a first side of the intermediate connecting element and a second portion overlapping a second side of the intermediate connecting element.

9. The connection arrangement of claim 8, wherein a width of the first portion of the first elongated side is shorter than a width of the second portion of the first elongated side.

10. The connection arrangement of claim 1, wherein the body of each of the first connector and the second connector comprises at least one fixed buckle configured for receiving at least a portion of a harness webbing therethrough.

11. The connection arrangement of claim 10, wherein the at least one fixed buckle has a bar spaced apart from the body of each of the first connector and the second connector by a gap and a pair of posts connecting terminal ends of the bar to the body of each of the first connector and the second connector.

12. The connection arrangement of claim 1, wherein the body of each of the first connector and the second connector comprises at least one adjustable buckle configured for receiving at least a portion of a harness webbing therethrough, the adjustable buckle having an adjustment mechanism configured for adjusting a position of at least one strap of the harness by selective frictional engagement with the at least one strap of the harness.

13. The connection arrangement of claim 12, wherein the adjustment mechanism comprises a frame connected at its terminal ends to the body of each of the first connector and the second connector with an opening between a central portion of the frame and the body of each of the first connector and the second connector, and an adjustment bar extending across the opening and movably engaged with the terminal ends of the frame.

14. The connection arrangement of claim 13, wherein the adjustment bar has an elongated body with terminal ends curved in a direction toward one another.

15. The connection arrangement of claim 13, wherein the frame has a lifting tab configured as an arcuate bend in the frame.

16. The connection arrangement of claim 1, wherein the body of at least one of the first connector and the second connector is substantially planar.

17. The connection arrangement of claim 1, further comprising a relief opening extending through the body of at least one of the first connector and the second connector.

18. A wearable body harness having a plurality of straps comprising:
a first shoulder strap and a second shoulder strap;
a first connector on the first shoulder strap, the first connector having a body with a first portion of a locking mechanism; and
a second connector on the second shoulder strap, the second connector having a body with a second portion of the locking mechanism,
wherein the first shoulder strap and the second shoulder strap are removably connectable to each other with engagement of the first connector and the second connector, and
wherein the first portion of the locking mechanism comprises:
a tab connected to the body of the first connector, and
a slot having a first portion extending through the body of the first connector and a second portion extending through the tab, and
wherein the second portion of the locking mechanism comprises:
a tongue configured for being received through the first portion of the slot on the first connector, and
an intermediate connecting element having a first end connected to the body of the second connector and a second end connected to the tongue, the second end of the intermediate connecting element being receivable in the second portion of the slot on the tab.

19. The wearable body harness of claim 18, wherein the first shoulder strap has a first portion connected to a first end of the first connector and a second portion connected to a second end of the first connector, and
wherein the second shoulder strap has a first portion connected to a first end of the second connector and a second portion connected to a second end of the second connector.

20. The wearable body harness of claim 18, wherein the first shoulder strap and the second shoulder strap are arranged in an X-shaped configuration at a front portion of the harness.
